(19) United States
(12) Patent Application Publication
(10) Pub. No.: US 2007/0138444 A1
(43) Pub. Date: Jun. 21, 2007

(54) Activated carbon having catalytic activity

(76) Inventor: Ernest De Ruiter, Leverkusen (DE)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/639,983

(22) Filed: Dec. 14, 2006

(30) Foreign Application Priority Data
Dec. 20, 2005 (DE) 10 2005 061 252.0
Mar. 9, 2006 (DE) 10 2006 010 862.0

(51) Int. Cl. H01B 1/04; C01B 31/02

(52) U.S. Cl. 252/502; 423/445 R

(57) ABSTRACT

The invention refers to a process for producing activated carbon having catalytic activity by carbonization and subsequent activation of carbonaceous organic polymers, wherein carbonaceous organic polymers into which, in the course of their formation, at least one metal atom and/or metal ion has been interpolymerized are subjected to a carbonization and subsequent activation, forming an activated carbon loaded with the metal atom and/or metal ion. This obviates subsequent loading with the metal by costly and inconvenient impregnation after the activated carbon has been produced. By endowing the starting materials with the metal, moreover, a more homogeneous loading is achieved, and that homogeneous throughout all kinds of pores (i.e. macropores, mesopores and micropores), so that catalytic activity is enhanced, and in addition, activation is accelerated.

### CROSS REFERENCES TO RELATED APPLICATIONS

This application claims priority to German Patent Application No. DE 10 2005 061 252.0, filed Dec. 20, 2005, and also claims priority to German Patent Application No. DE 10 2006 010 862.0, filed Mar. 9, 2006 entitled “ACTIVATED CARBON HAVING CATALYTIC ACTIVITY”. Both references are expressly incorporated by reference herein, in their entirety.

### BACKGROUND OF THE INVENTION

The present invention relates to a process for producing an activated carbon having catalytic activity, in particular in spherical form (“spherocarbon”), and also to the activated carbon produced in this way and to its use for a wide variety of applications, in particular for filters or for protective materials, for example protective suits and other kinds of protective apparel items (for example protective footwear, protective gloves, protective socks, protective underwear, protective headwear, etc).

Activated carbon has fairly unspecific adsorptive properties and therefore is the most widely used adsorbent. Legislative strictures as well as the rising sense of responsibility for the environment lead to a rising demand for activated carbon.

Activated carbon is generally produced by carbonization (also referred to by the synonyms of pyrolysis or else smouldering) and subsequent activation of suitable carbonaceous starting compounds, preferably such starting compounds as lead to economically reasonable yields. This is because the weight losses through detachment of volatile constituents in the course of carbonization and through the specific burn-out in the course of activation are appreciable.

For further details concerning the production of activated carbon, see for example H.v. Kienle and E. Bäader, “Aktivkohle und ihre industrielle Anwendung” (“Activated Carbon and Its Industrial Application”), Enke Verlag Stuttgart, 1980.

The constitution of the activated carbon produced—finely or coarsely porous, firm or brittle, granular or spherical—depends on the starting material. Customary starting materials are coconut shells, wood wastes, peat, bituminous coal, pitches, but also particular plastics which play a certain part in the production of woven activated carbon fabrics for example. In addition, organic polymers are also used as starting materials.

Activated carbon is used in various forms: pulverized carbon, splint coal carbon, granulocarbon, moulded carbon and also, since the end of the 1970s, spherical activated carbon (“spherocarbon”). Spherical activated carbon has a number of advantages compared with other forms of activated carbon that make it useful or even indispensable for certain applications. It is free flowing, enormously abrasion resistant, dustless and very hard.

Spherocarbon can be Produced by Various Processes:

One process for producing spherocarbon consists in producing spherules of bituminous coal tar pitch and suitable asphaltic residues from the petrochemical industry, which are oxidized to render them unmeltable, then smouldered and subsequently activated. Alternatively, spherocarbon can also be produced in a multistage process from bitumen. These multistage processes are very cost intensive and the associated high cost of spherocarbon prevents many applications wherein spherocarbon ought to be preferable by virtue of its properties.

Attempts have consequently been made to produce high-grade spherocarbon in some other way. Thus, it is prior art to produce activated carbon in the form of activated carbon spherules by carbonization and subsequent activation of new or used ion exchangers based on styrene-divinylbenzene resins containing sulphonic acid groups, or by carbonization of ion exchanger precursors in the presence of sulphuric acid and subsequent activation, the sulphonic acid groups and the sulphuric acid respectively having the function of a crosslinker. Such processes are described for example in DE 43 28 219 A1 and DE 43 04 026 A1 and also in DE 196 00 237 A1 including the German patent-of-addition application DE 196 25 069. WO 01/83368 A1 can further be cited in this connection. WO 98/07655 A1 discloses a process for producing activated carbon spherules wherein initially a mixture comprising a distillation residue from diisocyanate production and a carbonaceous processing assistant with or without one or more further additives is processed into free-flowing spherules which are subsequently smouldered and then activated.

The spherical activated carbon produced in the aforementioned manner can be used for example in protective suits, in particular so-called NBC protective suits for military or civil protection. Thus, the activated carbon can be used in particular in permeable, air-pervious adsorptive protective suits. Such protective suits possess a good protective effect with regard to chemical poisons, such as warfare agents (for example mustard gas or Hd), but often an only inadequate protective effect with regard to biological noxiants.

For this reason, such permeable, adsorptive filtering systems based on activated carbon are often equipped with a catalytically active component by endowing, in particular impregnating, the activated carbon with a biocidal or biostatic catalyst, in particular based on metals or metal compounds.

Such a protective material is described for example in DE 195 19 869 A1 which includes a multi-ply, textile, gas-pervious filtering material comprising an adsorptive layer based on activated carbon, in particular in the form of carbonized fibers, which is impregnated with a catalyst from copper, cadmium, platinum, palladium, mercury and zinc in amounts of 0.05% to 12% by weight, based on the activated carbon material. However, a subsequent impregnation of activated carbon is a costly and inconvenient operation, since the already-produced activated carbon has to be brought into contact with a suitable impregnating reagent, generally a solution or dispersion of the impregnating metal or of the impregnating metal compound, and subsequently dried once more. The impregnating operation thus has an adverse effect on the performance capability of the activated carbon used. Furthermore, the impregnating operation requires relatively large amounts of impregnating metal. Finally, a further disadvantage of a subsequent impregnation must be seen in the fact that a subsequent impregnation does not take place homogeneously throughout the entire activated carbon and more particularly not homogeneously throughout all the pores (i.e. macropores, mesopores and micropores). Lastly, a subsequent impregnation also impairs adsorption capacity, since pores in the activated carbon are partly clogged or blocked with the impregnating reagent and thus are no longer available for the adsorptive operation.

### BRIEF SUMMARY

A process is described for producing activated carbon having catalytic activity by carbonization and subsequent activation of carbonaceous organic polymers as starting material, the process using, as a starting material, carbonaceous organic polymers into which polymers, in the course of their formation or production, at least one metal has been interpolymerized wherein the polymers are subjected to a carbonization and a subsequent activation, thus forming an activated carbon loaded with the metal.

One object of the present disclosure is to describe a process for producing activated carbon having catalytic activity whereby the above-described disadvantages of the prior art are at least substantially obviated or alternatively at least ameliorated.

The present disclosure has for its object in particular to provide a production process for an activated carbon endowed with an impregnating or doping metal. The problem described above is solved in the realm of the present invention by a process according to the present disclosure. Further, advantageous embodiments of the process of the present invention are subject matter of the respective process subclaims.

The present disclosure further provides the activated carbon obtained in this way, as described and claimed.

The present disclosure yet further provides for the use of the activated carbon produced according to the present disclosure.

The present disclosure finally provides the products, in particular adsorptive materials, which are produced using the activated carbon obtainable according to the present disclosure.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

The present invention accordingly provides in a first aspect a process for producing activated carbon having catalytic activity or having metallic endowment by carbonization and subsequent activation of carbonaceous organic polymers, wherein carbonaceous organic polymers into which, in the course of their formation (i.e. their production or synthesis, respectively), at least one metal, preferably in the form of a metal atom and/or of a metal ion, has been interpolymerized are subjected to a carbonization and subsequent activation, forming an activated carbon loaded with the metal, in particular metal atom and/or metal ion.

In other words, the present invention provides a process for producing activated carbon endowed with a metal, preferably in the form of a metal atom and/or metal ion, wherein, first, polymerization is used to form carbonaceous organic polymers into which at least one metal, preferably in the form of a metal atom and/or metal ion, is interpolymerized and, in a subsequent step, the metal-loaded, carbonaceous organic polymers formed in this way are subjected to a carbonization and subsequent activation.

Because it is the starting materials, i.e. the carbonaceous organic polymers, which are endowed with the desired metal in the course of their formation there is no need for a costly and inconvenient impregnating step after the activated carbon has been produced. By endowing the polymeric starting materials with the metal, moreover, a more homogeneous loading can be achieved, and that homogeneous throughout all kinds of pores (macro-, meso- and micropores) of the activated carbon, so that catalytic activity is enhanced.

Applicant has found that, surprisingly, the efficacy with regard to biological and chemical poisons is raised—compared with a conventionally impregnated activated carbon—since the activated carbon produced according to the invention requires less metal for the same efficacy.

It is further surprising that the metals, in particular metal atoms and/or metal ions, in the organic starting polymers do not adversely affect the subsequent carbonization and activation. On the contrary, Applicant has found that, surprisingly and completely unexpectedly, the presence of the metals in the starting compounds speeds the subsequent operation, in particular the activation. Activation is complete in less time, compared with a carbon without metal loading. This was in no way foreseeable.

The interpolymerization of the metals into the carbonaceous organic starting polymers during formation thereof is thus associated with a multiplicity of advantages which are reflected not just in process-engineering terms but also in the products, as explained above (for example more homogeneous, more uniform loading and also enhanced catalytic activity).

Useful carbonaceous organic starting polymers for the purposes of the present invention may be in particular selected from the group of polystyrene polymers, in particular polystyrene-acrylate copolymers and polystyrene-divinylbenzene copolymers, preferably divinylbenzene-crosslinked polystyrenes; formaldehyde-phenolic resin copolymers, in particular formaldehyde-crosslinked phenolic resins; cellulose, in particular bead cellulose; and also mixtures thereof.

Particularly preferred carbonaceous organic starting polymers are polystyrene polymers, in particular polystyrene-divinylbenzene copolymers, preferably divinyl-benzene-crosslinked polystyrenes. Polymers used with preference according to the present invention have a divinylbenzene content of 1% to 20% by weight and preferably 4% to 18% by weight, based on the polymers, are used. While when divinylbenzene-crosslinked polystyrenes of the gel type are used as starting polymers a relatively low divinylbenzene content of 2% to 6% by weight and in particular 3% to 5% by weight is preferred, a relatively high divinylbenzene content of 15% to 20% by weight and in particular 17% to 19% by weight is preferred in the case of macroporous divinylbenzene-crosslinked polystyrenes used as starting polymers.

It is preferable according to the present invention for the polymers used to be granular and in particular spherical. This makes it possible to produce granular and in particular spherical activated carbon. The starting polymers used preferably have average diameters in the range from 0.01 to 2.0 mm, in particular in the range from 0.05 to 1.5 mm and preferably in the range from 0.1 to 1.0 mm—which then leads to the correspondingly dimensioned activated carbon particles.

The starting polymers are formed or polymerized in a manner known per se to a person skilled in the art. For this purpose, the starting monomers are made to polymerize in the presence of metals, in particular the metal atoms and/or the metal ions, preferably metal ions. For this purpose, the metal atom or atoms and/or metal ion or ions are added to the polymerization mixture, preferably in the form of a metal compound which is soluble or at least dispersible in the polymerization mixture; the starting mixture to be polymerized is then made to polymerize in the presence of the metal or metals. This can be accomplished for example through dispersion or emulsion polymerization, in particular free radical polymerization. For instance, to form divinylbenzene-crosslinked polystyrenes, a starting mixture of polystyrene and divinylbenzene (divinylbenzene content 1% to 10% by weight for example, based on the mixture) and also metal compound (for example behenate or (meth)acrylate of copper and/or of silver) can be free-radically polymerized in a conventional manner in the presence of a free radical initiator with or without a pore-former so as to produce the desired, metal-loaded organic starting polymers. It is preferable according to the present invention for the metal compounds in whose presence the polymerization is carried out to be organic compounds of the metals in question, in particular the metal salts of organic acids (for example behenates, acrylates, methacrylates, etc), since these can interpolymerize particularly homogeneously. For further details concerning the formation of the organic starting polymers as such reference may be made for example to U.S. Pat. No. 4,040,990 and U.S. Pat. No. 4,382,124, whose entire disclosure content in this regard is hereby incorporated herein by reference.

The metal, in particular metal atom and/or metal ion, can be used in variable amounts. It is used in particular in such amounts that the resulting polymer contains the metal or metals, in particular metal atoms and/or metal ions, in amounts of 0.001% to 10% by weight, in particular 0.005% to 5% by weight and preferably 0.01 % to 3% by weight, based on the polymer.

As previously described, the carbonaceous organic polymer produced in this way and subsequently to be subjected to a carbonization and subsequent activation contains at least one metal, preferably in the form of a metal atom and/or metal ion. The phrase “at least one metal” is to be understood as meaning the carbonaceous organic polymer contains at least one species or at least one variety of metal, in particular metal atom and/or metal ion. It is similarly possible to interpolymerize mutually different metals, in particular metal atoms and/or metal ions (for example mixtures of copper ions and silver ions etc).

The metal is in particular selected from the group of copper, silver, cadmium, platinum, palladium, rhodium, zinc, mercury, titanium, zirconium and/or aluminium and/or their mixtures and also the ions and/or salts. Preference is given to copper and/or silver and also their ions and/or salts.

The carbonaceous organic polymers loaded with metal atom which are produced in this way are then subjected to a carbonization and subsequent activation. Carbonization and activation are effected in a conventional manner. Reference for this may be made to the printed publications DE 43 28 219 A1, DE 43 04 026 A1, DE 196 00 237 A1, DE 196 25 069 A1 and WO 01/83368 A1 cited at the beginning, whose entire disclosure content in this regard is hereby incorporated herein by reference.

To obtain high yields in the activated carbon production process, it is advantageous to use such starting polymers as contain chemical groups which, when chemically decomposed, in particular under carbonization conditions, lead to free radicals and thus to crosslinks, in particular sulphonic acid and/or isocyanate groups, preferably sulphonic acid groups. Such chemical groups, in particular sulphonic acid groups, may already be present in the starting polymers used if sulphonated starting monomers are used for the polymerization, or the starting polymers formed are sulphonated after their polymerization. But it is preferable according to the present invention for these chemical groups, in particular sulphonic acid groups, not to be introduced until before and/or during the carbonization. This is accomplished by addition of a sulphonating reagent, preferably SO₃, to the starting polymers (for example by impregnating, drenching or wetting). Preferably, the SO₃ is used in the form of, in particular, concentrated sulphuric acid and/or oleum and more preferably in the form of a mixture of concentrated sulphuric acid and oleum. This is known as such to a person skilled in the art. Reference may be made in this context for example to the aforementioned WO 01/83368 A1 document, the DE 196 25 069 A1 document and the DE 196 00 237 A1 document, whose entire disclosure content in this regard is hereby incorporated herein by reference.

As previously mentioned, carbonization and activation are carried out in a conventional manner. Carbonization converts the carbonaceous polymeric starting material essentially to carbon; i.e., in other words, the polymeric starting material is carboned. Carbonization of the above-described organic polymeric spherules, in particular based on styrene and divinylbenzene, which contain functional chemical groups which, when thermally decomposed, lead to free radicals and thus to crosslinks, in particular sulphonic acid groups,—through detachment of volatile constituents, in particular of SO₂—destroys the functional chemical groups, in particular sulphonic acid groups, to form free radicals which effect a pronounced crosslinking—without which, after all, there would be no pyrolysis residue. In general, the carbonization is carried out under at least predominantly inert atmosphere (for example nitrogen) or at most slightly oxidizing atmosphere. In general, the carbonization is carried out at temperatures of 200 to 900° C. and preferably 250 to 850° C. As previously described, the carbonization is carried out under predominantly inert atmosphere or at most slightly oxidizing atmosphere; it may be advantageous for the predominantly inert atmosphere of the carbonization, in particular if it is carried out at comparatively high temperatures (for example in the range from about 500 to about 600° C.), to be admixed with a minor amount of oxygen, in particular in the form of air (for example 1% to 5%) in order that an oxidation of the carbonized polymer skeleton may be effected. The subsequent activation is facilitated in this way.

The carbonization is then followed by the activation. This activation is similarly effected under conditions known per se. The basic principle of activation is for a portion of the carbon generated in the course of the carbonization to be selectively degraded under suitable conditions. This gives rise to numerous pores, fissures and cracks, and the specific surface area increases considerably. The activation thus amounts to a specific burn-out of the carbon previously produced in the carbonization. Since carbon is degraded in the course of the carbonization, this operation is accompanied by a loss of substance which may be appreciable in some instances and which under optimal conditions is equivalent to an increase in the porosity and an increase in the internal surface area and the pore volume. The activation is therefore effected under selectively or controlledly oxidizing conditions. Customary activating gases are generally oxygen, in particular in the form of air, water vapor and/or carbon dioxide and also mixtures thereof. Since there is a danger with oxygen that it will act not selectively but over the entire surface (as a result of which the carbon burns off to a greater or lesser extent), water vapor and carbon dioxide are preferred. Very particular preference is given to water vapor, if appropriate in admixture with an inert gas (nitrogen for example). To achieve an industrially adequate reaction rate, the activation is generally carried out at temperatures in the range from about 800 to 1.200° C. and in particular in the range from 850 to 950° C.

Reaction management for carbonization and activation is known as such to a person skilled in the art, so that there is no need here to go into further details.

Carbonization and/or activation can be carried out in a rotary tube or alternatively in a fluidizing bed, in particular a fluidized bed. This is similarly known to a person skilled in the art.

The present invention further provides the activated carbon obtainable by the process of the present invention, in particular in granule form, preferably in the form of spherules. The activated carbon produced according to the present invention is notable for homogeneous, uniform loading with the desired impregnating or doping metal, and this homogeneously throughout all kinds of pores (macro-, meso- and also micropores). In particular, catalytic activity, in particular the action with regard to chemical and biological toxicants, is enhanced compared with a conventionally impregnated activated carbon.

The preference according to the present invention is for an activated carbon obtainable by the process of the present invention that has a large internal surface area (BET), in particular of at least 500 g/m², preferably at least 750 g/m², more preferably at least 1.000 g/m² and most preferably at least 1.200 g/m². Advantageously, the specific surface area (BET surface area) of the activated carbon produced according to the present invention is in the range from 500 to 2.500 g/m², in particular in the range from 750 to 2250 g/m², preferably in the range from 900 to 2.000 g/m² and more preferably in the range from 1.000 to 1.750 g/m².

The use of granular, in particular spherical, organic starting polymers gives an activated carbon having a high bursting pressure. This is at least 2 newtons, in particular at least 5 newtons per activated carbon particle, in particular activated carbon granule or activated carbon spherule, and is advantageously in the range from 2 newtons to 20 newtons and preferably in the range from 5 newtons to 20 newtons.

The activated carbon produced according to the present invention is useful for a multiplicity of applications, for example for producing adsorptive materials, such as adsorptive (sheet) filters, filtering mats, odor filters, sheet filters for protective apparel or protective suits, in particular for the civil and/or military sector, filters for indoor air cleaning, gas mask filters and adsorption-capable supporting structures.

In particular, the activated carbon produced according to the present invention can be used for producing protective materials of any kind, in particular protective suits or other protective apparel items (for example gloves, head covers, shoewear, socks, underwear, etc) against biological and/or chemical poisons, such as warfare agents, or alternatively for filters, in particular filters for removing noxiant, toxicant and/or odorant materials from air or gas streams.

The present invention finally further provides adsorptive materials, in particular filters of any kind, such as adsorptive (sheet) filters, odor filters, sheet filters for protective suits, in particular for the civil or military sector, such as protective suits or other protective apparel items against biological and/or chemical poisons, filters for indoor air cleaning, gas mask filters, filters for removing noxiant, toxicant and/or odorant materials from air or gas streams, filtering mats and adsorption-capable supporting structures, containing an activated carbon produced according to the present invention.

Further refinements, modifications and variations of the present invention will be readily apparent to and realizable by the ordinarily skilled on reading the description without their having to leave the realm of the present invention.

The present invention will now be illustrated with reference to the Examples hereinbelow which, however, shall in no way restrict the present invention.

### EXAMPLES

Formation of Starting Polymers:

a) Polymeric starting material useful according to the present invention for carbonization and subsequent activation is carried out in accordance with U.S. Pat. No. 4,382,124 by polymerization of styrene and divinylbenzene in the presence of benzoyl peroxide, a pore-former and silver behenate in aqueous dispersion to obtain a porous starting polymer doped with silver ions and based on divinylbenzene-crosslinked styrene in the form of spherical particles having diameters of 0.1 to 1.5 mm (overall fraction) having a silver ion content of about 1%, based on the polymers.

For comparison, a mixture without silver behenate is polymerized in the same way to obtain the corresponding polymers without the interpolymerization of silver ions.

b) The divinylbenzene-crosslinked styrene polymers formed in this way are thereafter subjected to a carbonization and subsequent activation. To this end, 1 kg of the previously formed, silver-loaded polymeric spherules (invention) or 1 kg of the previously formed polymeric spherules not loaded with silver ions (comparison) is each admixed with a mixture of 1 kg of oleum (25%) and ½ kg of concentrated sulphuric acid (96%) and subjected to a thermal treatment in a nitrogen atmosphere in an acid-resistant rotary tube oven from Plec (Cologne) for the purposes of carbonization, in accordance with the following thermal treatment:
heating to 200° C. at 2° C./min with a residence time of 20 minutes
heating to 300° C. at 3° C./min with a residence time of 10 minutes
heating to 400° C. at 5° C./min with a residence time of 10 minutes
heating to 800° C. at 3° C./min with a residence time of 20 minutes
heating to 900° C. at 3° C./min with a residence time of 10 minutes.
The result in each case is a carbonized material, the weight loss in each case, based on the dry substance, being about 10% (not only inventive but also comparative).

c) The material thus carbonized is then activated in the same rotary tube oven in each case at 800 to 900° C. with a mixture of 75% nitrogen and 25% water vapor and, following completion of the activation, cooled down in the oven. Whereas the total activation time is only 1½ hours in the case of the carbonized starting materials loaded with silver ions and used according to the present invention, the activation time is more than 3½ hours in the case of the carbonized comparative starting material, which contains no silver ions. This demonstrates a further advantage of the silver ion loading of the polymeric starting material with regard to the practice of activated carbon production, in particular the activating step.

The inventive starting materials give about 510 g of silver ion loaded activated carbon loaded with about 1.0% (% by weight) of silver ions, reckoned as silver and based on the activated carbon (average diameter: about 0.6 mm, BET: about 1450 g/m², bursting pressure: >5 newtons/spherule).

The comparative material gives about 440 g of activated carbon which thereafter is subjected to an impregnation with silver nitrate solution and subsequent drying, so that in the case of the comparative activated carbon the result is an activated carbon loaded with about 2% (% by weight) of silver ions, reckoned as silver and based on the activated carbon (average diameter: about 0.6 mm, BET: about 1.300 g/m², bursting pressure: >5 newtons/spherule), i.e. the silver ion content is about twice that of the activated carbon produced according to the present invention.

### Use Example:

The activated carbon produced according to the present invention is used to produce an adsorptive filtering material. For this purpose, a supporting layer having an areal weight of 25 g/m² (0.3 mm thickness) and an air transmission rate of 4.250 l·m⁻²·s⁻² for a flow resistance of 127 pascals has applied to it, by means of adhesive bonding, the activated carbon spherules produced according to the present invention at an add-on of 180 g/m² and the adsorptive layer is provided on the side remote from the supporting layer with a second supporting layer. The result is an adsorptive filtering material having an overall areal weight of 355 g/m² and an overall thickness (cross section) of 0.9 mm and having an air transmission rate of 680 l·m⁻²·s⁻² at a flow resistance of 127 pascals.

The comparative material is an identically constructed adsorptive filtering material with the difference that the adsorptive layer is formed by the subsequently impregnated comparative activated carbon whose silver ion content is twice that of the activated carbon produced according to the present invention.

The adsorptive filtering material produced with the activated carbon of the present invention, on the one hand, and the comparative adsorptive filtering material with the subsequently impregnated activated carbon, on the other, are subjected to the convection flow test of CRDEC-SP-84010 method 2.2 to determine their respective barrier effects with regard to mustard gas and soman. For this purpose, an air stream containing mustard gas or soman is flowed at a flow velocity of about 0.45 cm/s and a constant flow resistance against the adsorptive filtering material while the area-specific breakthrough amount after 16 hours is determined (80% relative humidity, 32° C., 10·1 μl HD/12.56 cm² or 12·1 μl GD/12.56 cm²).

The adsorptive filtering material comprising the activated carbon produced according to the present invention is found to have a breakthrough with regard to mustard gas of only 1.55 μg/cm² or 1.98 μg/cm and with regard to soman of only 1.85 μg/cm² or 1.66 μg/cm², whereas the comparative adsorptive filtering material comprising the subsequently impregnated activated carbon is found to have distinctly higher values which for both mustard gas and soman are above 5 μg/cm², and thus are not acceptable.

Tests on the adsorptive filtering material comprising the activated carbon produced according to the present invention for protective effects against microorganisms give similar, excellent results. In tests to check the biostatic properties to ASTM E2149-01 with Klebsiella pneumoniae or Staphylococcus aureus (in each case 1.5-3.0·10⁵ CFU/ml) the percentage reduction with regard to these pathogens after 24 hours is in both cases above 99% for the adsorptive filtering material comprising the activated carbon produced according to the present invention, whereas these values are only 70% and 75% respectively in the case of the comparative material comprising the subsequently impregnated activated carbon. This shows that biological protection due to the presence of the activated carbon produced according to the present invention is likewise improved.

The above tests document the improved performance capability of the activated carbon produced according to the present invention and incorporating the catalytically active component compared with a subsequently impregnated comparative activated carbon. Comparable results are obtained with activated carbons produced according to the present invention which, instead of a silver compound, incorporate a copper compound (copper methacrylate) or a mixture of copper and silver compounds (silver behenate and copper methacrylate).

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A process for producing activated carbon having catalytic activity by carbonization and subsequent activation of carbonaceous organic polymers as starting material, said process using, as a starting material, carbonaceous organic polymers into which polymers, in the course of their formation or production, at least one metal has been interpolymerized wherein said polymers are subjected to a carbonization and a subsequent activation, thus forming an activated carbon loaded with said metal.

2. The process according to claim 1, wherein the metal is used in the form of a metal atom or metal ion.

3. The process according to claim 1, wherein the polymers used are granular or spherical, having average particle diameters in the range of from 0.01 to 2.0 mm.

4. The process according to claim 1, wherein the polymers are selected from the group consisting of polystyrene polymers, polystyrene-acrylate copolymers, polystyrene-divinylbenzene copolymers and divinylbenzene-crosslinked polystyrenes; formaldehyde-phenolic resin copolymers and formaldehyde-crosslinked phenolic resins; cellulose and bead cellulose; as well as mixtures thereof.

5. The process according to claim 4, wherein polystyrene-divinylbenzene copolymers or the divinylbenzene-crosslinked polystyrenes having a divinylbenzene content of 1% to 20% by weight based on the polymers are used.

6. The process according to claim 1, wherein the metal is interpolymerized in the course of the formation or production of the polymers by adding the metal to the polymerization mixture or by carrying out the polymerization in the presence of the metal, wherein the metal is used in the form of a metal compound soluble or at least dispersible in the polymerization mixture.

7. The process according to claim 1, wherein the polymer used as the starting material contains the metal(s) in amounts of from 0.001% to 10% by weight based on the polymer.

8. The process according to claim 7, wherein the polymer used as the starting material contains the metal(s) in amounts of from 0.005% to 5% by weight based on the polymer.

9. The process according to claim 1, wherein the polymer used as the starting material is formed by dispersion polymerization, emulsion polymerization or free radical polymerization.

10. The process according to claim 1, wherein the metal is selected from the group consisting of copper, silver, cadmium, platinum, palladium, rhodium, zinc, mercury, titanium, zirconium, aluminium and their ions, salts and mixtures.

11. The process according to claim 10, wherein the metal is selected from the group consisting of copper, silver and their ions, salts and mixtures.

12. The process according to claim 1, wherein the polymer used as the starting material contains chemical groups which, when chemically decomposed under carbonization conditions, lead to free radicals and thus to crosslinks, wherein said chemical groups are selected from the group consisting of sulphonic acid groups, isocyanate groups and mixtures thereof.

13. The process according to claim 1, wherein the carbonization is carried out at temperatures of from 200 to 900° C. in an at least essentially inert atmosphere.

14. The process according to claim 1, wherein the activation is carried out at temperatures of from 800 to 1.200° C. in an at least essentially inert or slightly oxidizing atmosphere.

15. The process according to claim 1, wherein at least one of the carbonization and the activation is carried out in a rotary tube or in a fluidized bed.

16. An activated carbon obtainable by the process of claim 1, said activated carbon being loaded or doped with at least one metal.

17. The activated carbon according to claim 16, wherein the metal is present in the form of a metal atom or of a metal ion.

18. The activated carbon according to claim 16, wherein the activated carbon has the form of a granule or spherule.

19. The activated carbon according to claim 16, said activated carbon being characterized by an internal BET surface area in the range of from 500 to 2.500 g/m² and by a bursting pressure of at least 2 newtons per activated carbon particle.

20. The activated carbon according to claim 16, said activated carbon containing the metal(s) in amounts of from 0.001% to 10% by weight based on the activated carbon.

21. Use of an activated carbon obtainable by the process according to claim 1 for producing adsorptive materials, adsorptive filters and protective apparel.

22. Adsorptive material, said adsorptive material comprising the activated carbon obtainable by the process according to claim 1.

23. The adsorptive material according to claim 22, said adsorptive material being selected form the group consisting of adsorptive filters, adsorptive sheet filters, filtering mats, odor filters, NBC protective apparel, NBC protective suits and adsorption-capable supporting structures.
